(19) United States
(12) Patent Application Publication
(10) Pub. No.: US 2025/0303363 A1
(43) Pub. Date: Oct. 2, 2025

(54) PORTABLE AIR PURIFIER

(71) Applicant: Hanon Systems, Daejeon (KR)

(72) Inventors: Ji-Yong PARK, Daejeon (KR); Jae Ho KIM, Daejeon (KR); Hyun Jun KIM, Daejeon (KR)

(73) Assignee: Hanon Systems, Daejeon (KR)

(21) Appl. No.: 19/061,840

(22) Filed: Feb. 24, 2025

(30) Foreign Application Priority Data
Mar. 28, 2024 (KR) 10-2024-0042281

(51) Int. Cl. B01D 53/88; B01D 46/00; B01D 46/52; B01D 53/00

(52) U.S. Cl. CPC B01D 53/885; B01D 46/0028; B01D 46/0047; B01D 46/521; B01D 53/007; B01D 2257/91; B01D 2258/06; B01D 2259/802; B01D 2273/30; B01D 2279/65

(57) ABSTRACT

A portable air purifier of the present invention includes a housing and a purification module accommodated inside the housing, the purification module including an upper case, a lower case, a support, a blower fan, and a purification unit. In the portable air purifier, the support is formed in a replaceable type to be attachable to and detachable from the upper case and the lower case, which makes it possible to manufacture various types of portable air purifiers to correspond to different air purification types by replacing a minimum number of parts, thereby making manufacturing processes easy and reducing manufacturing costs.

### CROSS-REFERENCE TO RELATED APPLICATIONS

This application claims priority under 35 U.S.C. § 119 to Korean Patent Application No. 10-2024-0042281, filed on Mar. 28, 2024, in the Korean Intellectual Property Office, the disclosure of which is incorporated herein by reference in its entirety.

### TECHNICAL FIELD

The following disclosure relates to a portable air purifier, and more particularly, to a portable air purifier capable of purifying air using a photocatalytic reaction or a filter.

### BACKGROUND

Recently, the problem of indoor and outdoor air pollution has been rapidly increasing, and the demand for portable air purifiers for providing purified air to individuals or purifying air in narrow spaces such as vehicle interiors has been increasing.

Most existing portable air purifiers are filter-type purifiers and electrostatic precipitation-type purifiers. However, the filter-type purifiers are inconvenient because it is necessary to periodically replace filters and have high air flow resistance, and the electrostatic precipitation-type purifiers generate nitrogen oxides and ozone that are harmful to human bodies.

In addition, photocatalytic-type portable air purifiers only function to remove harmful gases and airborne microorganisms such as bacteria and viruses by applying the photocatalytic technology to small packages.

The portable air purifiers manufactured in various ways as described above are different in terms of the kinds of components that are used and the arrangement of the components, and accordingly, have component fixing structures in different forms.

In order to manufacture various types of portable air purifiers, it is necessary to manufacture fixing structures that are different depending on what air purification type is adopted, which require a large number of molds, making manufacturing and management processes difficult and costly.

### PRIOR ART DOCUMENT

### Patent Document

KR 10-2189493 B1 (Dec. 4, 2020) entitled “PORTABLE AIR PURIFIER”

### SUMMARY

An object of the present invention is to provide a portable air purifier that can be manufactured in various types corresponding to different air purification types by replacing a minimum number of parts.

In one general aspect, a portable air purifier includes: a housing having an inlet hole through which outside air is introduced and an outlet hole through which the air is discharged; and a purification module accommodated inside the housing and purifying air introduced through the inlet hole, in which the purification module includes an upper case, a lower case disposed to be spaced apart from and below the upper case, a support coupled to the upper case and the lower case, a blower fan coupled to an upper side of the upper case and circulating air between the outside and the inside of the housing, and a purification unit disposed between the upper case and the lower case and purifying air.

The support may be detachably assembled to the upper case and the lower case.

The upper case and an upper end of the support may be fitted to each other.

A fixing pin may be formed to project from the upper case, and a fixing hole corresponding to the fixing pin may be formed in an upper end of the support, so that the fixing pin is inserted into the fixing hole to couple the support to the upper case.

A fixing pin may be formed to project from an upper end of the support, and a fixing hole corresponding to the fixing pin may be formed in the upper case, so that the fixing pin is inserted into the fixing hole to couple the support to the upper case.

The upper case and an upper end of the support may be coupled to each other by a bolt.

A catching projection may be formed to project from the lower case, a radially inner side of a lower end of the support may be propped against the catching projection by contacting the catching projection, and a lower surface of the lower end of the support may be propped against an upper surface of the lower case by contacting the upper surface of the lower case.

The upper case may include a body, a step projection formed to project from an inner circumferential surface of the body, and a support piece radially connecting different locations of the inner circumferential surface of the body, and an insertion groove may be formed in the step projection.

The purification unit of the purification module may include a light source unit emitting light, and a photocatalytic member spaced apart from and around the light source unit to cause a photocatalytic reaction by the light emitted from the light source portion, and the light source unit and the photocatalytic member may be coupled to at least one of the upper case and the lower case.

An upper end of the support may be propped against a lower end of the upper case by contacting the lower end of the upper case, and a catching projection may be formed to project from the lower case, a radially inner side of a lower end of the support may be propped against the catching projection by contacting the catching projection, and a lower surface of the lower end of the support may be propped against an upper surface of the lower case by contacting the upper surface of the lower case.

The purification unit of the purification module may include a filter coupled to the support.

The purification unit may further include: a light source provided in the support and emitting light; and a photocatalytic member disposed to be spaced apart from the light source and surrounded by the filter, and coupled to at least one of the upper case and the lower case.

The purification module may further include a main control board, and the lower case may have a board accommodating space formed upward concavely from a lower surface thereof, and the main control board may be accommodated in the board accommodating space of the lower case.

The purification module may further include a lower cover coupled to a lower end of the lower case.

The portable air purifier of the present invention is advantageous in that various types of portable air purifiers can be manufactured to correspond to different air purification types by replacing a minimum number of parts, thereby making manufacturing processes easy and reducing manufacturing costs.

### BRIEF DESCRIPTION OF THE DRAWINGS

FIGS. 1 and 2 are an assembled perspective view and an exploded perspective view showing a portable air purifier according to a first embodiment of the present invention.

FIG. 3 is an assembled perspective view showing a purification module of the portable air purifier according to the first embodiment of the present invention.

FIGS. 4 and 5 are an assembled perspective view and an exploded perspective view showing a coupling structure between an upper case and a support of the portable air purifier according to the first embodiment of the present invention.

FIGS. 6 to 8 are cross-sectional views showing the portable air purifier according to the first embodiment of the present invention.

FIG. 9 is an exploded perspective view showing a portable air purifier according to a second or third embodiment of the present invention.

FIG. 10 is an exploded perspective view showing a purification module of the portable air purifier according to the second or third embodiment of the present invention.

FIGS. 11 to 13 are cross-sectional views showing the portable air purifier according to the second or third embodiment of the present invention.

### DETAILED DESCRIPTION OF EMBODIMENTS

Hereinafter, a portable air purifier of the present invention having the configuration described above will be described in detail with reference to the accompanying drawings.

### First Embodiment—Catalyst Type

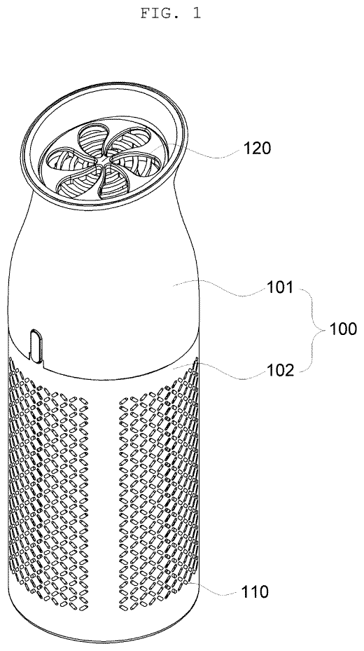

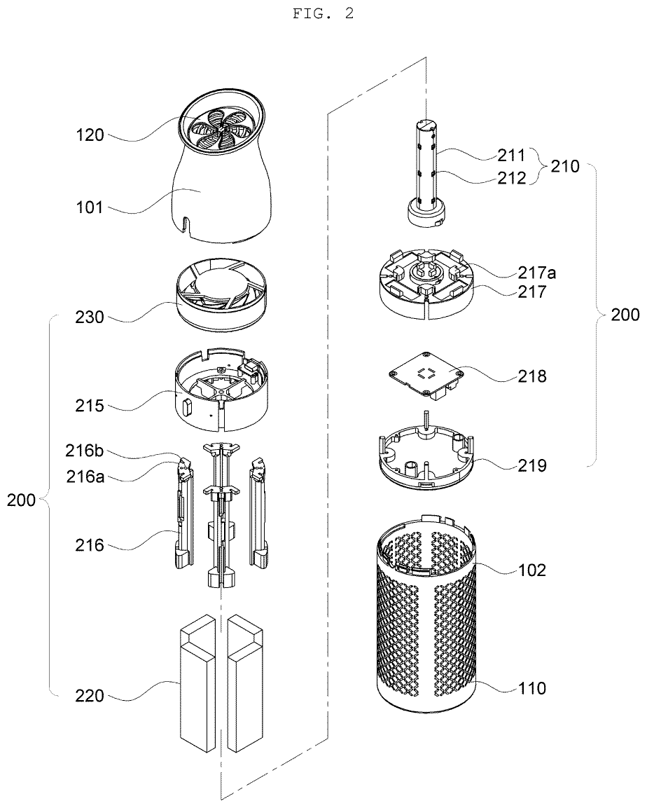

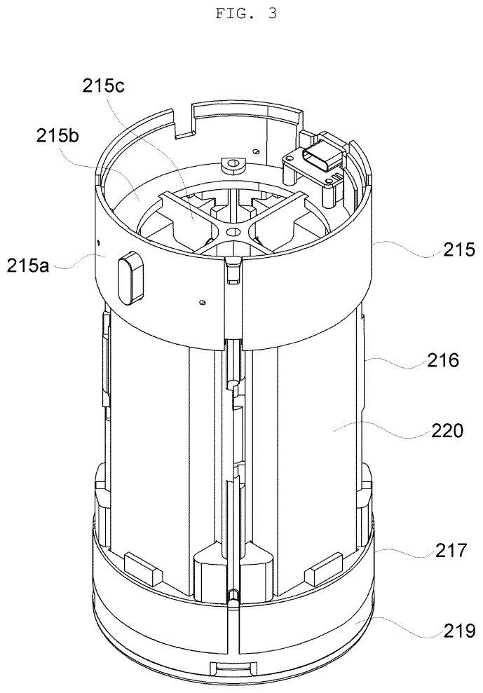

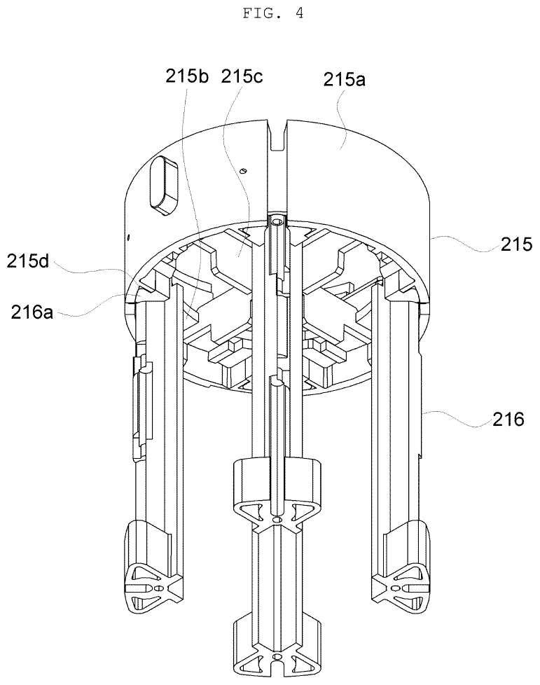

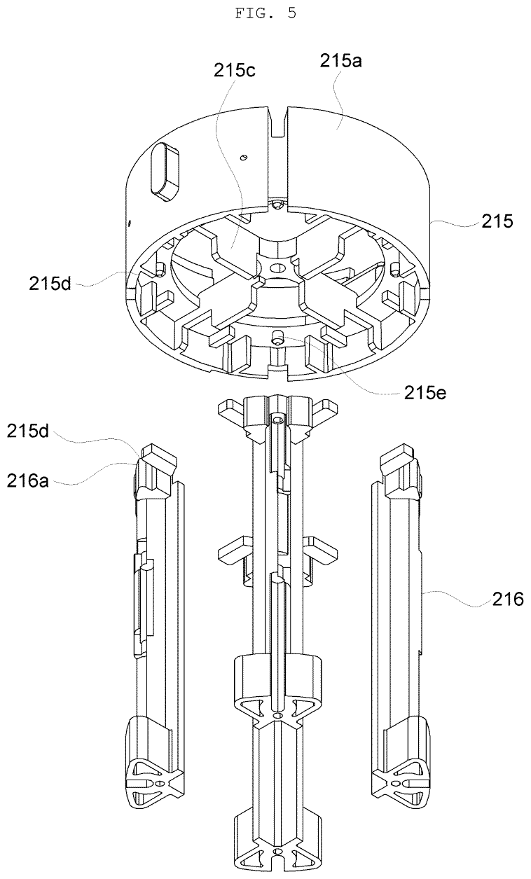

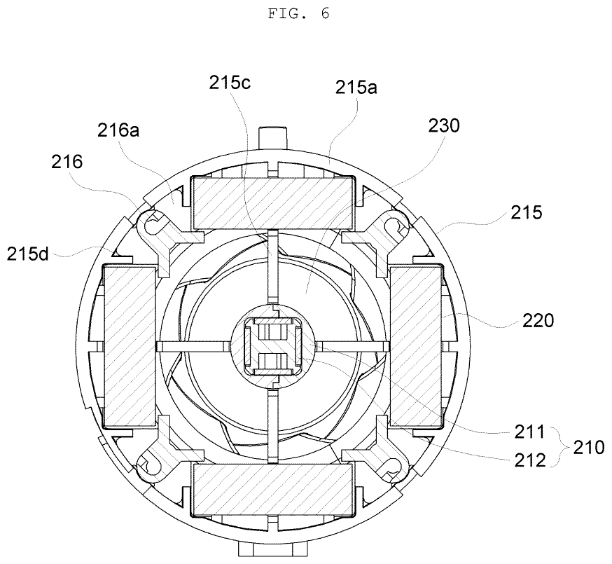

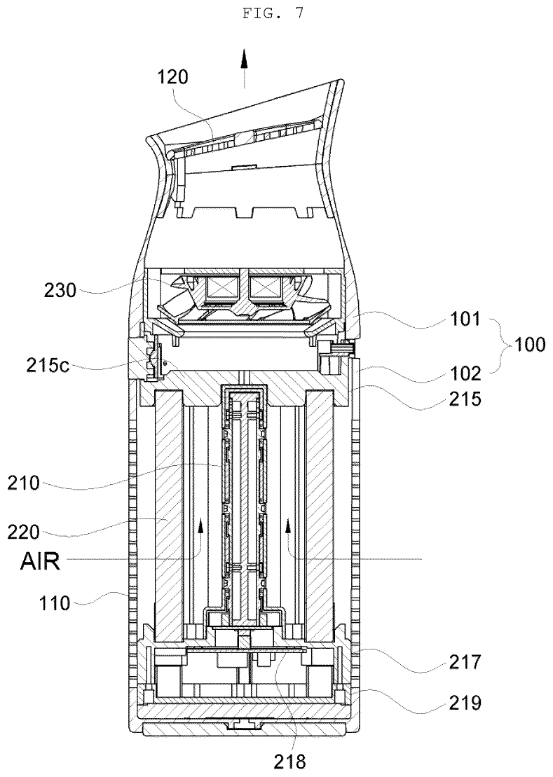

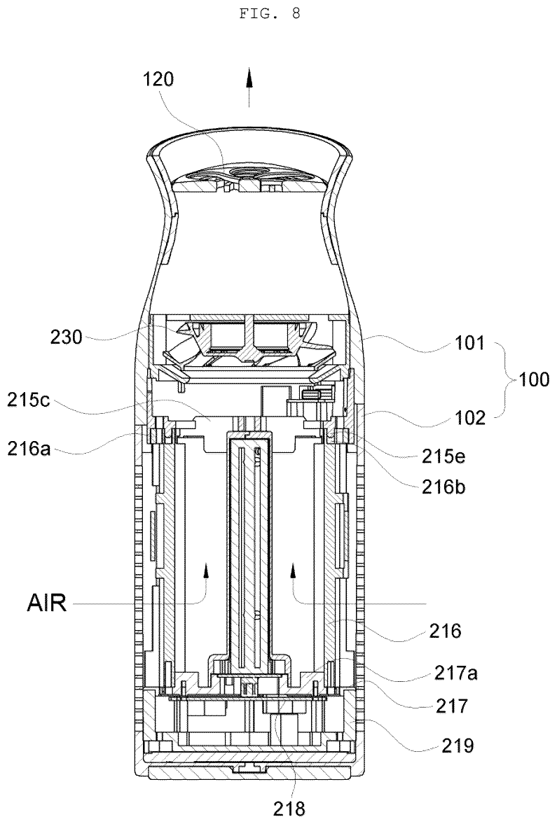

FIGS. 1 and 2 are an assembled perspective view and an exploded perspective view showing a portable air purifier according to a first embodiment of the present invention, FIG. 3 is an assembled perspective view showing a purification module of the portable air purifier according to the first embodiment of the present invention, FIGS. 4 and 5 are an assembled perspective view and an exploded perspective view showing a coupling structure between an upper case and a support of the portable air purifier according to the first embodiment of the present invention, and FIGS. 6 to 8 are cross-sectional views showing the portable air purifier according to the first embodiment of the present invention.

As illustrated, the portable air purifier according to the first embodiment of the present invention mainly includes a housing 100 and a purification module 200.

The housing 100 may be formed like a container that is hollow inside, and the housing 100 may have a plurality of inlet holes 110 through which air is introduced from the outside to the inside and an outlet hole 120 through which air is discharged from the inside to the outside. For example, the housing 100 may include an upper housing 101 and a lower housing 102 to form a separable structure. The upper housing 101 may be formed to be hollow inside while being open at a lower end thereof with the outlet hole 120 formed at an upper end thereof. The lower housing 102 may be formed like a cylinder with an open upper end and a closed lower end, and the plurality of inlet holes 110 may be formed to penetrate the outer and inner circumferential surfaces of the side wall of the lower housing 102 having a cylindrical shape. In addition, the lower end of the upper housing 101 may be coupled to the upper end of the lower housing 102, so that the upper housing 101 and the lower housing 102 communicate with each other.

The purification module 200 may include an upper case 215, a lower case 217, a support 216, a blower fan 230, and a purification unit. The purification module 200 may be accommodated inside the housing 100 and coupled to the housing 100, and the purification module 200 may serve to purify air flowing into the housing 100 and discharge the purified air to the outside of the housing 100.

The upper case 215 may include a body 215a, a step projection 215b, and a support piece 215c. For example, the body 215a may be formed like a cylinder, and the ring-like step projection 215b may be formed inward in the radial direction from the inner circumferential surface of the body 215a. In addition, a plurality of support pieces 215c may be formed to extend inward in the radial direction from the inner circumferential surface of the body 215a, and the plurality of support pieces 215c may meet at the center of the body 215a and be connected to each other. In addition, the plurality of support pieces 215c may be arranged to be spaced apart from each other in the circumferential direction to allow air to pass through the upper case 215 in the vertical direction between the plurality of support pieces 215c. In addition, an insertion groove 215d may be formed concavely in the step projection 215b. The lower case 217 may be positioned to be spaced apart from and below the upper case 215.

The lower case 217 may be substantially formed like an overturned cup, and a catching projection 217a may be formed to project on an upper surface of the lower case 217. A plurality of catching projections 217a may be provided, and the plurality of catching projections 217a may be arranged to be spaced apart from each other in the circumferential direction.

The support 216 may be formed like a column elongated in the vertical direction. A plurality of supports 216 may be provided, and the plurality of supports 216 may be arranged to be spaced apart from each other in the circumferential direction. The plurality of supports 216 may be coupled to at least one of the upper case 215 and the lower case 217. For example, upper ends of the plurality of supports 216 may be detachably coupled to the upper case 215, and lower ends of the plurality of supports 216 may be propped against the lower case 217 by contacting the lower case 217. Each of the plurality of supports 216 may have a coupling portion 216a formed at the upper end thereof, and the coupling portion 216a may be formed in a shape corresponding to the insertion groove 215d of the upper case 215, and inserted into the insertion groove 215d to couple each of the plurality of supports 216 to the upper case 215. In addition, a fixing pin 215e may be formed to project downward from the upper case 215, and a fixing hole 216b corresponding to the fixing pin 215e may be formed in the upper end of the support 216, so that the fixing pin 215e is inserted into the fixing hole 216b to couple the support to the upper case 215. By doing so, the upper end of the support 216 can be firmly coupled to the upper case 215. In addition, the lower end of the support 216 may be propped against the lower case 217 by contacting the lower case 217, a radially inward side of the lower end of the support 216 may be propped against the catching projection 217a of the lower case 217 by contacting the catching projection 217a of the lower case 217 so that the support 216 is not pushed inward in the radial direction, and a lower surface of the lower end of the support 216 may be propped against the upper surface of the lower case 217 by contacting the upper surface of the lower case 217. By doing so, after coupling the plurality of supports 216 to the upper case 215, the lower case 217 can be assembled. That is, the support 216 can be detachably assembled to the upper case 215 and the lower case 217. In addition, the lower ends of the plurality of supports 216 can be detachably coupled to the lower case 217, and the upper case 215 can be propped against the upper ends of the plurality of supports 216 by contacting the upper ends of the plurality of supports 216. Alternatively, the upper ends of the plurality of supports 216 may be detachably coupled to the upper case 215, and the lower ends of the plurality of supports 216 may be detachably coupled to the lower case 217.

The blower fan 230 may be coupled to an upper side of the upper case 215. For example, the blower fan 230 may be an axial fan that blows air from the lower side to the upper side. By operating the blower fan 230, air can be circulated between the outside and inside of the housing 100.

The purification unit may be disposed between the upper case 215 and the lower case 217 to serve to purify air. The purification unit may include a light source unit 210 and a photocatalytic member 220. The light source unit 210 may emit light, and the photocatalytic member 220 may be spaced apart from and around the light source unit 210 to cause a photocatalytic reaction by the light emitted from the light source unit 210 so that air is purified. The light source unit 210 and the photocatalytic member 220 may be coupled to at least one of the upper case 215 and the lower case 217. As illustrated, upper ends of the light source unit 210 and the photocatalytic member 220 may be coupled and fixed to the upper case 215, and lower ends of the light source unit 210 and the photocatalytic member 220 may be coupled and fixed to the lower case 217. In addition, the light source unit 210 may be disposed in a central portion surrounded by the plurality of supports 216 inside the plurality of supports 216, and a plurality of photocatalytic members 220 may be provided, each being disposed between the supports 216. By doing so, outside air flows into the housing 100 through the inlet holes 110 of the housing 100, is purified while passing through the photocatalytic member 220, flows upward between the photocatalytic member 220 and the light source unit 210, passes through the blower fan 230, and then is discharged to the outside through the outlet hole 120 of the housing 100.

Since the portable air purifier of the present invention is formed in a structure in which the support is detachably assembled to the upper case and lower case, the structure of the present invention is capable of forming a mold for manufacturing the upper case in a smaller size, making manufacturing processes easier and reducing manufacturing costs, as compared with the existing structure in which the upper case and the support are formed as a single body. In addition, even if the structure or type of the portable air purifier changes, it is only needed to replace the support because the upper case can be used in common in any structure or type of portable air purifier, thereby making manufacturing processes easier.

In addition, the upper case 215 and the upper end of the support 216 may be fitted to each other. That is, as described above, the coupling portion 216a projecting outward from the outer circumferential surface at the upper end of each of the plurality of supports 216 may be inserted into the insertion groove 215d formed in the upper case 215 to couple each of the plurality of supports 216 to the upper case 215. Alternatively, a coupling portion may be formed to project from the upper case 215 and an insertion groove may be formed in the upper end of each of the plurality of supports 216, so that the projecting portion is inserted into the insertion groove to couple each of the plurality of supports 216 to the upper case 215.

In addition, as described above, the fixing pin 215e may be formed to project from the upper case 215, and the fixing hole 216b corresponding to the fixing pin 215e may be formed in the upper end of each of the plurality of supports 216, so that the fixing pin 215e is inserted into the fixing hole 216b to couple each of the plurality of supports 216 to the upper case 215. Alternatively, a fixing pin may be formed to project from the upper end of each of the plurality of supports 216, and a fixing hole corresponding to the fixing pin may be formed in the upper case 215, so that the fixing pin is inserted into the fixing hole to couple each of the plurality of supports 216 to the upper case 215.

In addition, the upper case 215 and the upper end of each of the plurality of supports 216 may be coupled to each other by a bolt. For example, a through hole may be formed in the upper case 215, a female thread may be formed at the upper end of each of the plurality of supports 216, a bolt may pass through the through hole from the upper side of the upper case 215 and be fastened to the female thread of the support 216, and the head of the bolt may be caught by the upper case 215 to couple each of the plurality of supports 216 to the upper case 215. In addition, the plurality of supports may be coupled to the upper case in various other forms using bolts.

In addition, the light source unit 210 may include a light source case 211 and a light source 212. For example, the light source 212 may be an LED bar that generates visible light. The LED bar may include an LED board and an LED chip integrally mounted on the LED board. In addition, the LED bar may be formed like a bar or strip elongated in the vertical direction. In addition, a plurality of LED bars may be provided as the light source 212. The light source case 211 may be formed like a tube elongated in the vertical direction. In addition, an upper end of the light source unit 210 may be inserted into a groove formed in a central portion of the support piece 215c in the radial direction of the upper case 215 to couple the light source unit 210 to the upper case 215, and a lower end of the light source unit 210 may be coupled to a central portion of the lower case 217.

The photocatalytic member 220 may cause a photocatalytic reaction when exposed to visible light emitted from the light source unit 210. For example, the light source 212 may emit visible light having a wavelength of about 400 nm to 700 nm, and the photocatalytic member 220 may be made of a material that causes a photocatalytic reaction when exposed to visible light (a material including TiO2, WO3, Pt, or the like). In addition, a plurality of photocatalytic members 220 may be provided to be spaced apart from each other around the light source unit 210 with the light source unit 210 as the center. For example, the photocatalytic members 220 may be located at positions corresponding to the four sides of the light source unit 210, respectively. In addition, the photocatalytic members 220 may be formed of a porous material coated with a photocatalyst, and air flowing into the housing 100 through the inlet holes 110 may pass through the photocatalytic members 220. By doing so, when the photocatalytic member 220 is irradiated with visible light, a photocatalytic reaction occurs in the photocatalytic member 220, generating superoxygen radicals. The superoxygen radicals generated in this way have a high oxidation potential, so that when air passes through the photocatalytic member 220, harmful substances in the air can be oxidized and rendered harmless. In addition, an upper end of the photocatalytic member 220 may be inserted into a groove formed on an outer side of the support piece 215c in the radial direction of the upper case 215 to couple the photocatalytic member 220 to the upper case 215, and a lower end of the photocatalytic member 220 may be inserted into a groove formed concavely from the upper surface of the lower case 217 to couple the photocatalytic member 220 to the lower case 217.

In addition, the purification module may further include a main control board 218. The lower case 217 may have a board accommodating space formed upward concavely from the lower side thereof to accommodate the main control board 218 in the board accommodating space. In addition, the purification module may further include a lower cover 219, and the lower cover 219 may be coupled to the lower side of the lower case 217 so that the lower cover 219 covers and blocks the open lower end of the lower case 217.

### Second Embodiment—Filter Type

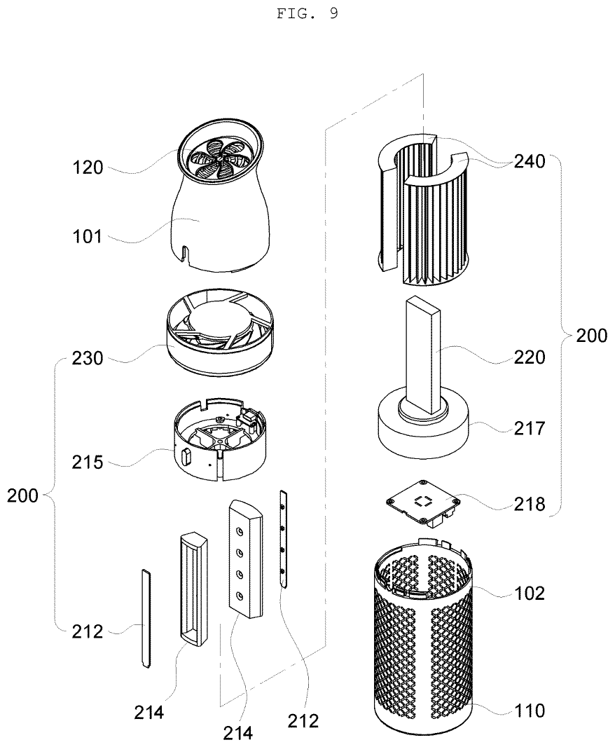

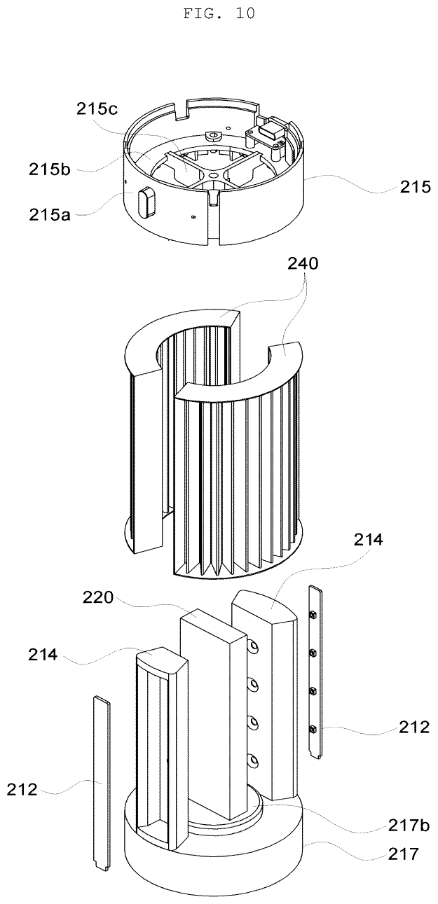

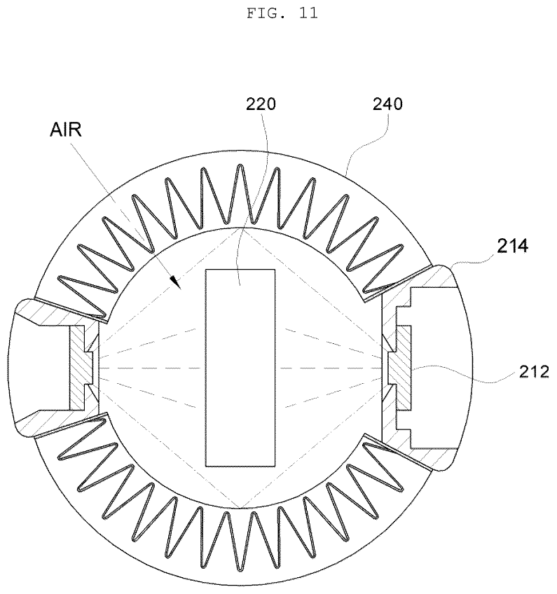

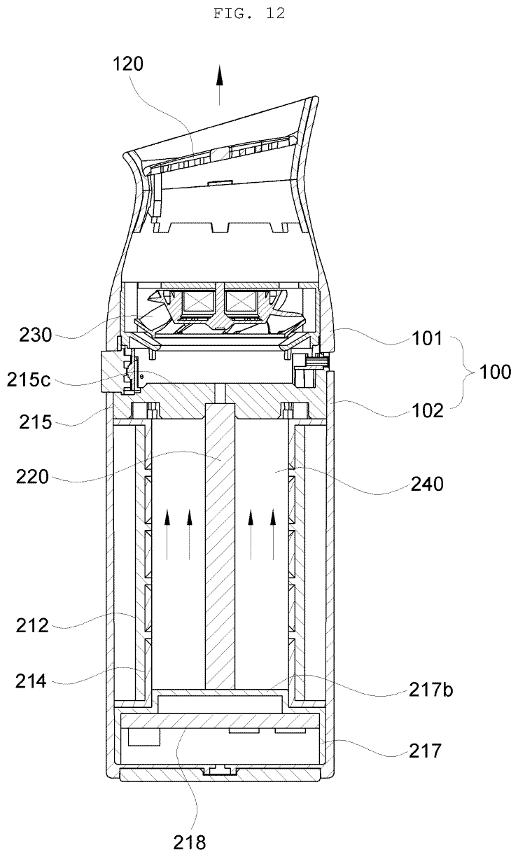

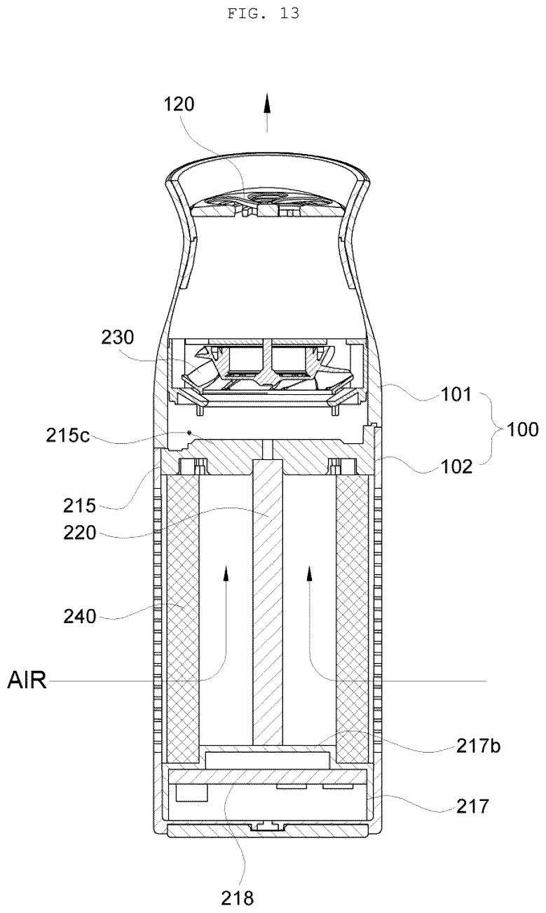

FIG. 9 is an exploded perspective view showing a portable air purifier according to a second or third embodiment of the present invention, FIG. 10 is an exploded perspective view showing a purification module of the portable air purifier according to the second or third embodiment of the present invention, and FIGS. 11 to 13 are cross-sectional views showing the portable air purifier according to the second or third embodiment of the present invention.

As described above, the portable air purifier according to the second embodiment of the present invention may include a housing 100 and a purification module 200.

The housing 100 may be formed in the same manner as in the first embodiment.

The purification module may include an upper case 215, a lower case 217, a support 214, a blower fan 230, and a purification unit. The purification module 200 may be accommodated inside the housing 100 and coupled to the housing 100, and the purification module 200 may serve to purify air flowing into the housing 100 and discharge the purified air to the outside of the housing 100.

The upper case 215 may be formed in the same manner as in the first embodiment.

The lower case 217 may be substantially formed like an overturned cup, and a catching projection 217b may be formed to project upward from an upper surface in a central portion of the lower case 217.

The support 214 may be formed like a column elongated in the vertical direction. For example, a pair of supports 214 may be formed to be spaced apart from each other by 180 degrees in the circumferential direction, and the pair of supports 214 may be arranged to face each other. An upper end of the support 214 may be propped against a lower end of the upper case 215 by contacting the lower end of the upper case 215, a radially inward side of a lower end of the support 214 may be propped against the catching projection 217b so that the support 214 is not pushed inward in the radial direction, and a lower surface of the lower end of the support 214 may be propped against an upper surface of the lower case 217 by contacting the upper surface of the lower case 217. By doing so, the upper case 215 can be assembled after assembling the pair of supports 214 to the lower case 217. That is, the support 214 can be detachably assembled to the upper case 215 and the lower case 217. The blower fan 230 may be formed in the same manner as in the first embodiment.

The purification unit may include a filter 240 coupled to the support 214. Both ends in the circumferential direction of the filter 240 may be coupled to the supports 214. For example, a plurality of filters 240 may be provided, and the plurality of filters 240 may be arranged between the pair of supports 214 in the circumferential direction. Each of the filters 240 may be formed in such a manner that the overall appearance thereof has a curved shape and assembled toward the inward side from the outward side in the radial direction. In addition, a lower end of the filter 240 may be propped against the lower case 217 by contacting the lower case 217, and an upper end of the filter 240 may be propped against the upper case 215 by contacting the upper case 215.

Additionally, the purification module may further include a main control board 218, as in the first embodiment, and may further include a lower cover 219.

### Third Embodiment—Filter Type+Catalyst Type

The portable air purifier according to the third embodiment of the present invention has a configuration in which a light source 212 and a photocatalyst member 200 are added to the second embodiment.

For example, the support 214 may have a light source accommodating space formed inward concavely from an outer side surface in the radial direction to accommodate the light source 212, and the support 214 may have an opening penetrating both surfaces in the radial direction. A plurality of LED bars may be provided as the light source 212, and the LED bars may be provided in the pair of supports 214, respectively. Here, the LED chip of the LED bar may be inserted into the opening of the support 214, and the LED board may be propped again the support 214 by contacting the support 214.

The photocatalytic member 220 may be positioned to be spaced apart from the support 214. For example, the photocatalytic member 220 may be positioned at the center in the radial direction between the pair of supports 214 so that the photocatalytic member 220 is irradiated with light on both sides. In addition, the photocatalytic member 220 may be surrounded by the filter 240 and the pair of supports 214. In addition, the photocatalytic member 220 may be coupled to at least one of the upper case 215 and the lower case 217. For example, the upper end of the photocatalytic member 220 may be inserted into a groove formed in a central portion of the support piece 215c of the upper case 215 to couple the photocatalytic member 220 to the upper case 215, and the lower end of the photocatalytic member 220 may be propped against the lower case 217 by contacting the lower case 217.

The present invention is not limited to the above-described embodiments, and may be applied in various forms. Various modifications may be made by any person having ordinary knowledge in the art to which the present invention pertains without departing from the gist of the present invention claimed in the claims.

### DETAILED DESCRIPTION OF MAIN ELEMENTS

100: Housing
101: Upper housing
102: Lower housing
110: Inlet hole
120: Outlet hole
200: Purification module
210: Light source unit
211: Light source case
212: Light source
214: Support
215: Upper case
215a: Body
215b: Step projection
215c: Support piece
215d: Insertion groove
215e: Fixing pin
216: Support
216a: Coupling portion
216b: Fixing hole
217: Lower case
217a: Catching projection
217b: Catching projection
218: Main control board
219: Lower cover
220: Photocatalytic member
230: Blower fan
240: Filter

What is claimed is:

1. A portable air purifier comprising:
a housing having an inlet hole through which outside air is introduced and an outlet hole through which the air is discharged;
and
a purification module accommodated inside the housing and purifying air introduced through the inlet hole,
wherein the purification module includes an upper case, a lower case disposed to be spaced apart from and below the upper case, a support coupled to the upper case and the lower case, a blower fan coupled to an upper side of the upper case and circulating air between the outside and the inside of the housing, and a purification unit disposed between the upper case and the lower case and purifying air.

2. The portable air purifier of claim 1, wherein the support is detachably assembled to the upper case and the lower case.

3. The portable air purifier of claim 2, wherein the upper case and an upper end of the support are fitted to each other.

4. The portable air purifier of claim 2, wherein a fixing pin is formed to project from the upper case, and a fixing hole corresponding to the fixing pin is formed in an upper end of the support, so that the fixing pin is inserted into the fixing hole to couple the support to the upper case.

5. The portable air purifier of claim 2, wherein a fixing pin is formed to project from an upper end of the support, and a fixing hole corresponding to the fixing pin is formed in the upper case, so that the fixing pin is inserted into the fixing hole to couple the support to the upper case.

6. The portable air purifier of claim 2, wherein the upper case and an upper end of the support are coupled to each other by a bolt.

7. The portable air purifier of claim 2, wherein a catching projection is formed to project from the lower case, a radially inner side of a lower end of the support is propped against the catching projection by contacting the catching projection, and a lower surface of the lower end of the support is propped against an upper surface of the lower case by contacting the upper surface of the lower case.

8. The portable air purifier of claim 2, wherein the upper case includes a body, a step projection formed to project from an inner circumferential surface of the body, and a support piece radially connecting different locations of the inner circumferential surface of the body, and an insertion groove is formed in the step projection.

9. The portable air purifier of claim 2, wherein the purification unit of the purification module includes a light source unit emitting light, and a photocatalytic member spaced apart from and around the light source unit to cause a photocatalytic reaction by the light emitted from the light source portion, and the light source unit and the photocatalytic member are coupled to at least one of the upper case and the lower case.

10. The portable air purifier of claim 1, wherein an upper end of the support is propped against a lower end of the upper case by contacting the lower end of the upper case, and
a catching projection is formed to project from the lower case, a radially inner side of a lower end of the support is propped against the catching projection by contacting the catching projection, and a lower surface of the lower end of the support is propped against an upper surface of the lower case by contacting the upper surface of the lower case.

11. The portable air purifier of claim 10, wherein the purification unit of the purification module includes a filter coupled to the support.

12. The portable air purifier of claim 11, wherein the purification unit further includes:
a light source provided in the support and emitting light; and
a photocatalytic member disposed to be spaced apart from the light source and surrounded by the filter, and coupled to at least one of the upper case and the lower case.

13. The portable air purifier of claim 1, wherein the purification module further includes a main control board, and
the lower case has a board accommodating space formed upward concavely from a lower surface thereof, and the main control board is accommodated in the board accommodating space of the lower case.

14. The portable air purifier of claim 13, wherein the purification module further includes a lower cover coupled to a lower end of the lower case.
